(19) United States
(12) Patent Application Publication
(10) Pub. No.: US 2011/0016495 A1
(43) Pub. Date: Jan. 20, 2011

(54) TERMINAL AND METHOD FOR RECEIVING FRAMES OF BROADCAST DATA

(75) Inventor: Seok Min HWANG, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/837,946

(22) Filed: Jul. 16, 2010

(30) Foreign Application Priority Data
Jul. 16, 2009 (KR) 10-2009-0064871

(51) Int. Cl. H04N 7/16

(52) U.S. Cl. 725/62

(57) ABSTRACT

A user terminal and method are provided for receiving broadcast data based on frames. A determination is made whether the broadcast data is transmitted via a primary RS frame for transmitting first broadcast data or a secondary RS frame for transmitting second broadcast data. When the broadcast data is transmitted via the secondary RS frame for the second broadcast data, a channel state of a channel through which a frame containing the second broadcast data is transmitted is checked. When the checked channel state is greater than or equal to a preset first channel state, only the second broadcast data contained in the secondary RS frame is received. Therefore, the user terminal can periodically receive frames containing its necessary broadcast data and can thus reduce power consumption.

### PRIORITY

This application claims priority under 35 U.S.C. §119(a) to an application filed in the Korean Intellectual Property Office on Jul. 16, 2009, and assigned Serial No. 10-2009-0064871, the contents of which are incorporated herein by reference.

### BACKGROUND OF THE INVENTION

1. Field of the Invention

The present invention relates generally to digital broadcast technology, and more particularly, to a terminal and method that can periodically receive frames containing broadcast data, and thus reduce power consumption.

2. Description of the Related Art

Mobile broadcast systems that are capable of providing broadcast data include Digital Multimedia Broadcasting (DMB), Digital Video Broadcasting-Handheld (DVB-H), Media Forward Link Only (FLO), Advanced Television System Committee-Mobile/Handheld (ATSC-MH), etc. The ATSC-MH system is a mobile broadcast system that is commonly used in North America, which transfers broadcast data in frames.

The ATSCH-MH system requires error correction and synchronization to receive data. In order to perform error correction in the ATSCH-MH system, each frame is required to employ error correction coding, such as Serial Concatenated Convolutional Code (SCCC) and Read-Solomon (RS). The application of the error correction coding works well if the broadcast data is received in frames.

Broadcast data includes video and audio broadcast data. Video and audio broadcast data are included in different frames for transmission to a user terminal. Video broadcast data contains image data such as a moving image. Video broadcast data is transmitted at a high data rate, but has a disadvantage in that an even a small error can cause interruptions or pauses on a display screen. To resolve this problem, video broadcast data is transmitted together with a training sequence that can estimate a channel.

The audio broadcast data contains traffic information, weather information, and voice information, such as, visual radio. In most cases, the audio broadcast does not need channel estimation if a data rate is not required.

In some cases the terminal receives only frames containing audio broadcast data, but it usually also receives frames containing information for channel estimation. When this occurs, the terminal wastes power on the frames that should not have been received.

### SUMMARY OF THE INVENTION

The present invention has been made to address at least the above problems and/or disadvantages and to provide at least the advantages described below. Accordingly, an aspect of the present invention provides a terminal for receiving frames containing broadcast data, periodically, and a method for reducing power consumption by allowing the terminal to receive only necessary frames.

According to one aspect of the present invention, a method is provided for receiving frames containing broadcast data. It is determined whether the broadcast data is transmitted via a primary RS frame for transmitting first broadcast data or a secondary RS frame for transmitting second broadcast data. When the broadcast data is transmitted via the secondary RS frame for the second broadcast data, a channel state of a channel through which a frame containing the second broadcast data is transmitted is checked. When the checked channel state is greater than or equal to a preset first channel state, only the second broadcast data contained in the secondary RS frame is received.

According to another aspect of the present invention, a broadcast data receiving terminal is provided. The terminal includes a frame receiving unit for receiving broadcast data contained in at least one of a primary RS frame for transmitting first broadcast data and a secondary RS frame for transmitting second broadcast data. The terminal also includes a channel state checking unit for checking a channel state of a channel through which the broadcast data is transmitted. The terminal further includes a controller. The controller determines whether the broadcast data is the first broadcast data received via the primary RS frame or the second broadcast data received via the secondary RS frame. When the broadcast data is the second broadcast data, the controller checks the channel state of the channel through which a frame containing the second broadcast data is transmitted. When the checked channel state is greater than or equal to a preset first channel state, the controller receives only the second broadcast data contained in the secondary RS frame.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a data structure of a frame, according to an embodiment of the present invention;

FIG. 2 is a diagram illustrating a time slicing structure of a frame, according to an embodiment of the present invention;

FIG. 3 is a diagram illustrating a parade structure, according to an embodiment of the present invention;

FIG. 4 is a diagram illustrating a data structure of a slot, according to an embodiment of the present invention;

FIG. 5 is a diagram illustrating a training sequence, according to an embodiment of the present invention;

FIG. 6 is a timing chart for receiving data contained in a slot, according to an embodiment of the present invention;

FIG. 7 is a schematic block diagram illustrating a broadcast receiving terminal, according to an embodiment of the present invention;

FIG. 8 is a flow chart that illustrates a method for receiving frames, according to an embodiment of the present invention; and

FIG. 9 is a flow chart that illustrates a method for receiving a training sequence, according to an embodiment of the present invention.

### DETAILED DESCRIPTION OF EMBODIMENTS OF THE PRESENT INVENTION

Embodiments of the present invention are described in detail with reference to the accompanying drawings. The same or similar reference numbers may be used throughout the drawings to refer to the same or similar parts. Detailed descriptions of constructions or processes known in the art may be omitted to avoid obscuring the subject matter of the present invention.

The terms or words used in the present description and the claims should not be limited by a general or lexical meaning, and instead should be analyzed as a meaning and a concept through which the inventor defines and describes the present invention in his best effort, to comply with the idea of the present invention. Therefore, one skilled in the art will understand that the embodiments disclosed in the description and configurations illustrated in the drawings are only preferred embodiments. There may be various modifications, alterations, and equivalents thereof to replace the embodiments at the time of filing this application.

The term ‘user terminal’ refers to a terminal that can receive broadcast data provided by broadcast service providers and can output the broadcast data. The user terminal includes all types of terminals and their applications that can receive and output broadcast data, for example, television sets, portable terminals, laptop computers, computers, etc.

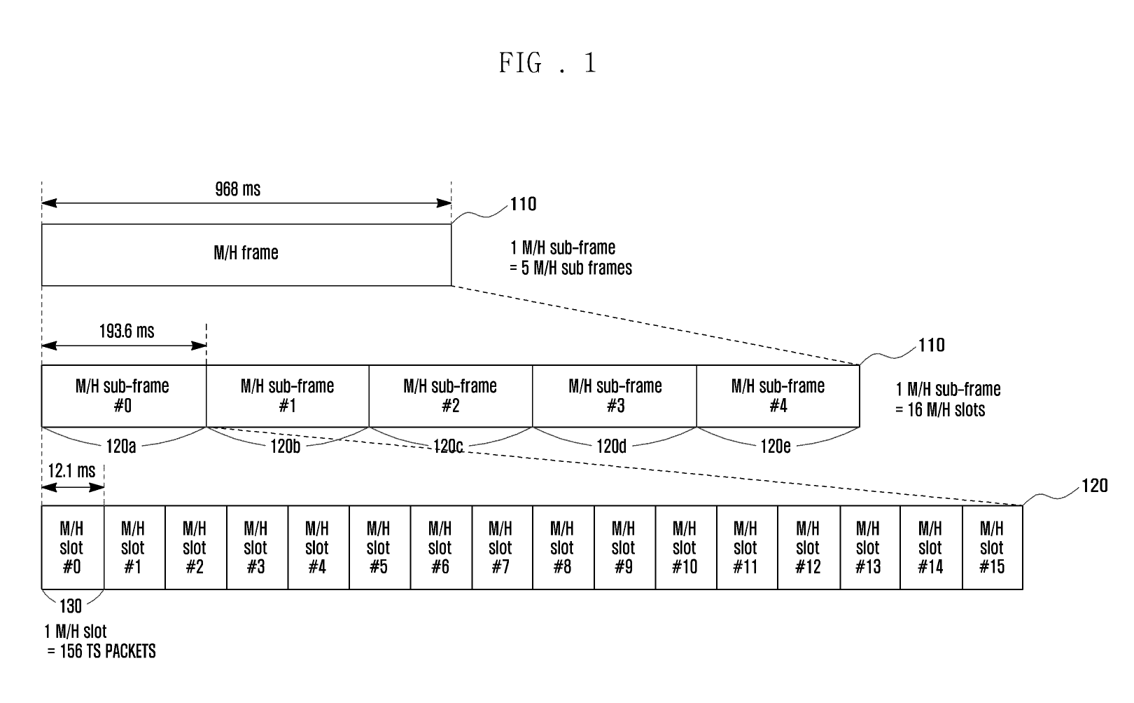

FIG. 1 is a diagram illustrating a data structure of a frame, according to an embodiment of the present invention.

A frame 110 contains broadcast data. The frame 100 has a duration of 968 ms, and includes five sub-frames 120a, 12b, 120c, 120d, and 120e. One sub-frame has a duration of 193.6 ms and includes 16 slots. A slot 130 has a duration of 12.1 ms and includes 156 transmission packets.

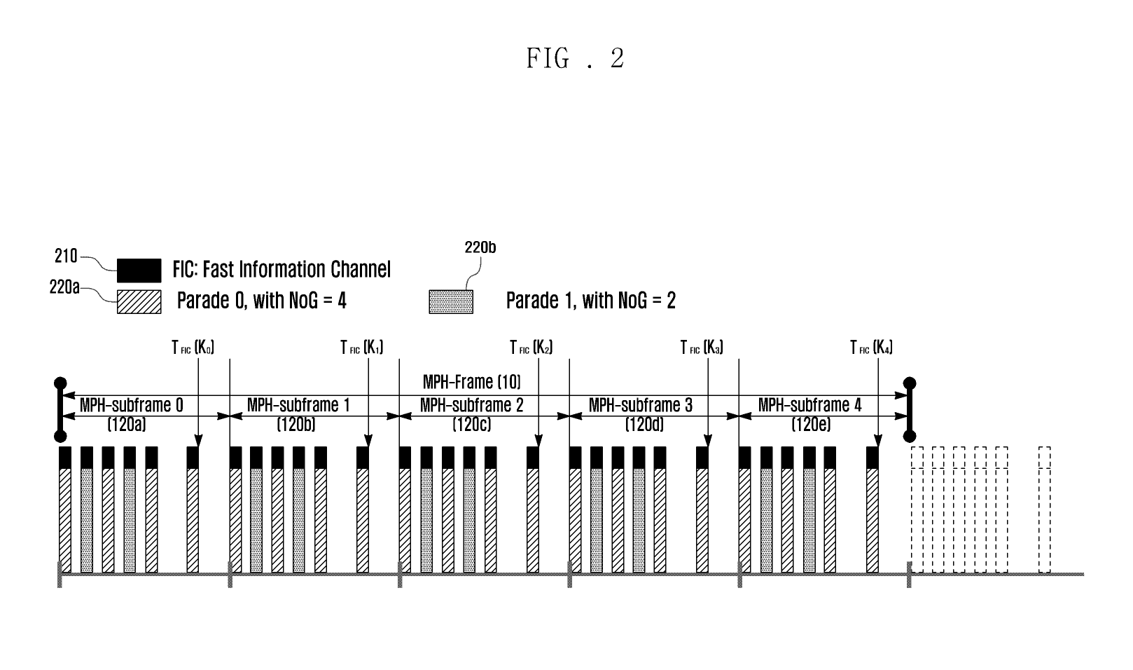

In an embodiment of the present invention, in order to estimate a channel according to the types of frames through which broadcast data is received, a user terminal can receive training sequences inserted into the frame 110, step by step, according to a channel state. The user terminal is required to check a frame transmitted from a channel selected by a user. For example, the user terminal can check a frame through which broadcast data is received, via a parade, i.e., a frame structure based on time. The structure of one frame based on time is described in detail with reference to FIG. 2.

FIG. 2 is a diagram illustrating a time slicing structure of a frame, according to an embodiment of the present invention.

One frame includes a plurality of parades 220a and 220b, each of which contains a Fast Information Channel (FIC) 210. Each of the plurality of parades 220a and 220b is arrayed in a certain pattern. For example, as shown in FIG. 2, one frame has 5 sub-frames 120a, 120b, 120c, 120d, and 120e, each of which includes six parades having a certain pattern.

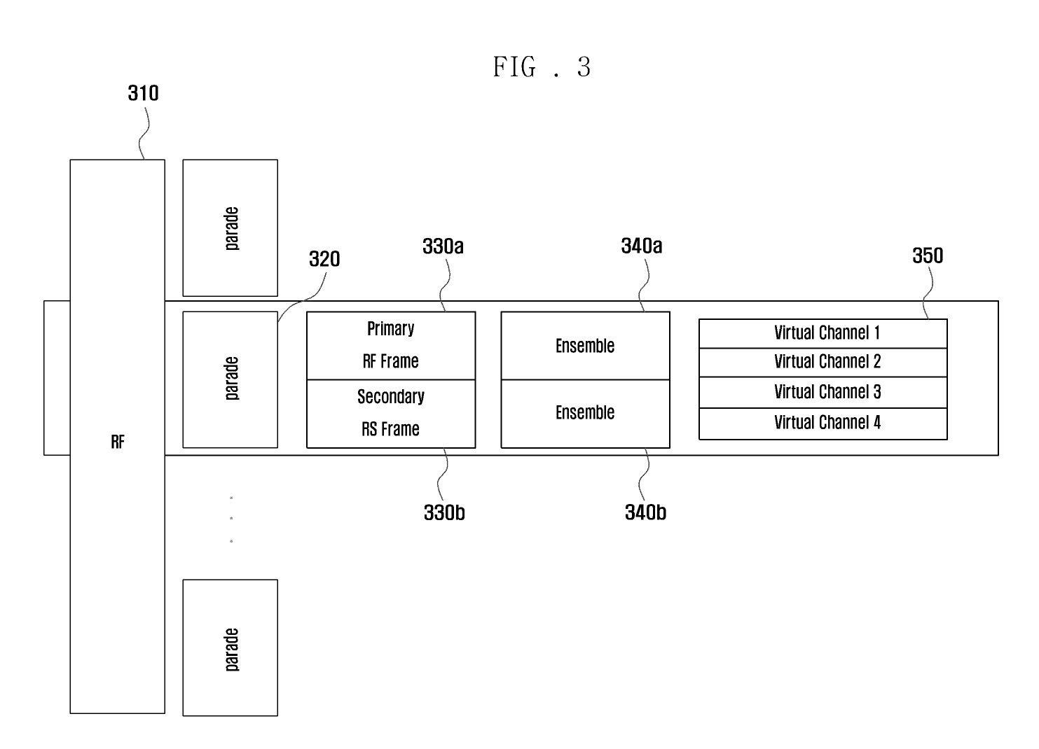

FIG. 3 is a diagram illustrating a parade structure, according to an embodiment of the present invention.

Broadcast data is transmitted to the user terminal via a Radio Frequency (RF) band 310 allocated to each broadcast service provider. Broadcast data is transmitted in frames, and one frame includes a plurality of parades. A parade 320 may include two RS frames, referred to as a primary RS frame 330a and a secondary RS frame 330b, respectively. The parade 320 must have the primary RS frame 330a, but may optionally include the secondary RS frame 330b. The parade 320 also has ensembles 340a and 340b, each of which contains at least one broadcast service 350 providing broadcast data.

The primary RS fame 330a contains the first broadcast data, such as video broadcast data and a training sequence to correct errors and to estimate a channel. The secondary RS frame 330b contains the second broadcast data, such as traffic information, weather information, visual radio information, audio broadcast data, etc.

The user terminal checks an ensemble containing broadcast data corresponding to a broadcast service selected by a user. The user terminal then detects which parade the checked ensemble is transmitted through. The user terminal receives a corresponding parade and extracts broadcast data corresponding to the user's selected broadcast service therefrom.

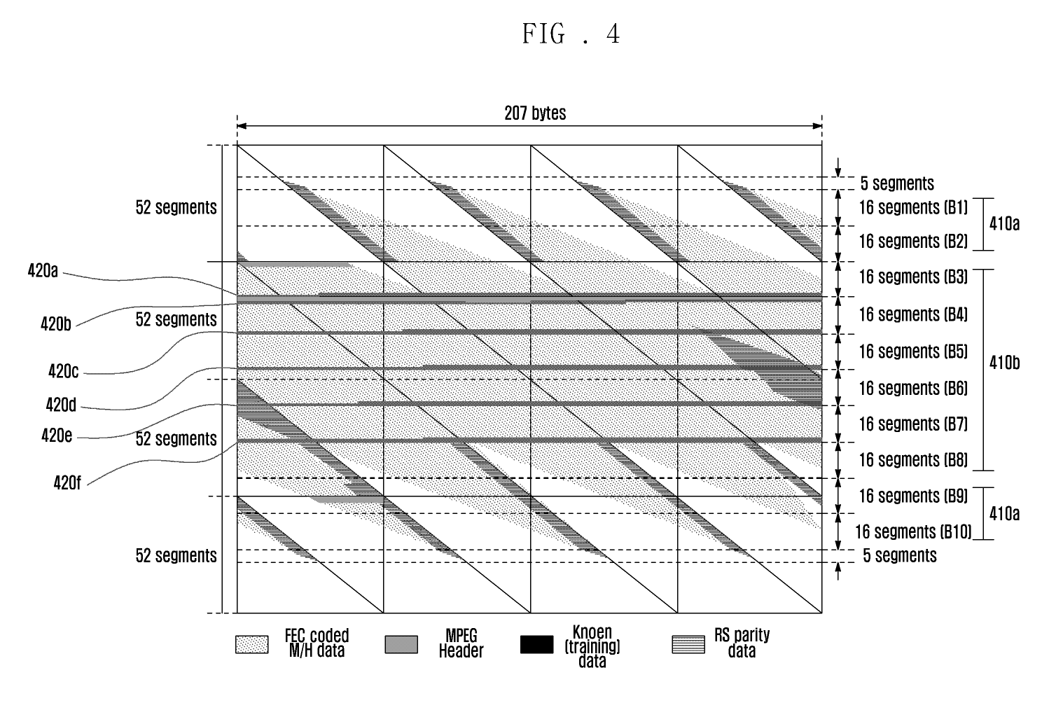

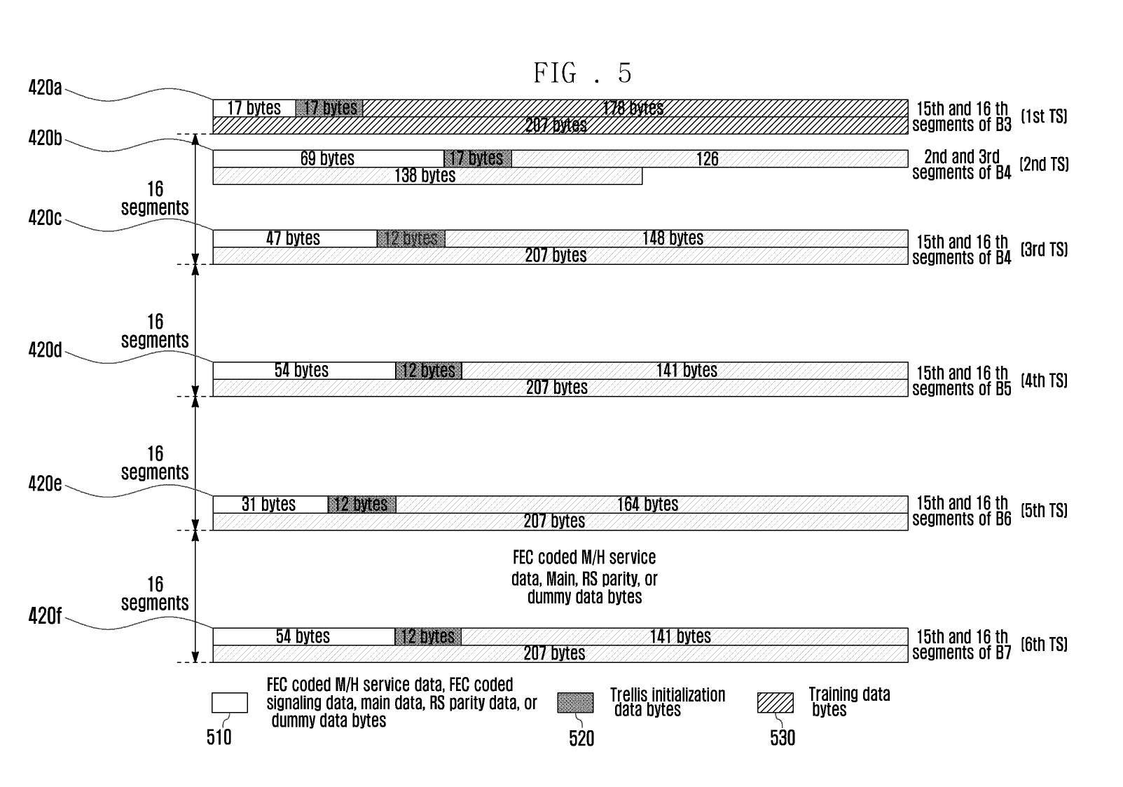

In order to output the extracted broadcast data, the user terminal requires channel estimation. To estimate a channel, the user terminal requires channel estimation information, i.e., a training sequence. The training sequence is located in the slots contained in the frame. The training sequence is described in greater detail with reference to FIGS. 4 and 5.

FIG. 4 is a diagram illustrating a data structure of a slot, according to an embodiment of the present invention.

The slot has a size of 207 bytes and includes 204 segments. The slot contains information related to broadcast data, such as Forward Error Correction (FEC) coded Mobile/Handheld (M/H) data, Moving Picture Experts Group (MPEG) header, Trellis init. data, Known data, signaling data, RS parity data, Dummy data, etc. The slot has a plurality of areas, each of which is divided into blocks B1 to B10 (410a, 410b). Each of the blocks B1 to B10 includes 10 segments.

B1, B2, B9 and B10 (410a) correspond to an area to which the second broadcast data contained in the secondary RS frame is transmitted. The second broadcast data refers to audio broadcast data, traffic information, weather information, visual radio information, etc.

B3-B8 (410b) correspond to an area to which the broadcast data contained in the primary RS frame is transmitted. The primary RS frame transmits video broadcast data such as a moving image, and a training sequence for estimating a channel, serving as Known data.

The training sequence has six types: a first training sequence 420a in B3, second and third training sequences 420b and 420c in B4, a fourth training sequence 420d in B5, a fifth training sequence 420e in B6, and a sixth training sequence 420f in B7. The training sequences located in B3 to B7 are described in greater detail with reference to FIG. 5.

FIG. 5 is a diagram illustrating a training sequence, according to an embodiment of the present invention.

Referring to FIG. 5, the first training sequence 420a is located at the 15^{th} and 16^{th} segments in B3 and transmitted first. The first training sequence 420a includes: FEC coded M/H service data, FEC coded signal data, main data, RS parity data or dummy data (510), forming 17 bytes; trellis initialization data (520), forming 12 bytes; and training data (530), forming 178 bytes and 207 bytes. The training data 530 refers to channel estimating information for synchronizing time of broadcast data. In an embodiment of the present invention, if the channel state is to greater than or equal to a value of the first channel state when frames containing broadcast data that the user desires are received, the user terminal receives broadcast data located in B1 and B2, the first training sequence 420a, and the remaining broadcast data located in B9 and B10.

The second training sequence 420b is located at the 2nd and 3^{rd} segments in B4 and is transmitted second. The second training sequence 420b includes: FEC coded M/H service data, FEC coded signal data, main data, RS parity data or dummy data (510), forming 69 bytes; trellis initialization data (520), forming 12 bytes; and training data (530), forming 126 bytes and 138 bytes. The training data 530 refers to channel estimating information for synchronizing time of broadcast data. In an embodiment of the present invention, if the channel state is greater than or equal to a value of the second channel state when frames containing broadcast data that the user desires are received, the user terminal receives broadcast data located in B1 and B2, the first and second training sequences 420a and 420b, and the secondary RS frame located in B9 and B10.

The third training sequence 420c is located at the 15^{th} and 16′^{th} segments in B4 and is transmitted third. The third training sequence 420c includes: FEC coded M/H service data, FEC coded signal data, main data, RS parity data or dummy data (510), forming 47 bytes; trellis initialization data (520), forming 12 bytes; and training data (530), forming 148 bytes and 207 bytes. The training data 530 refers to channel estimating information for synchronizing time of broadcast data. In an embodiment of the present invention, if the channel state is greater than or equal to a value of the third channel state when frames containing broadcast data that the user desires are received, the user terminal receives broadcast data located in B1 and B2, the first to third training sequences 420a to 420c, and the secondary RS frame located in B9 and B10.

The fourth training sequence 420d is located at the 15^{th} and 16′^{th} segments in B5 and is transmitted fourth. The fourth training sequence 420d includes: FEC coded M/H service data, FEC coded signal data, main data, RS parity data or dummy data (510), forming 54 bytes; trellis initialization data (520), forming 12 bytes; and training data (530), forming 141 bytes and 207 bytes. The training data 530 refers to channel estimating information for synchronizing time of broadcast data. In an embodiment of the present invention, if the channel state is greater than or equal to a value of the fourth channel state when frames containing broadcast data that the user desires are received, the user terminal receives broadcast data located in B1 and B2, the first to fourth training sequences 420a to 420d, and the secondary RS frame located in B9 and B10.

The fifth training sequence 420e is located at the 15^{th} and 16^{th} segments in B6 and is transmitted fifth. The fifth training sequence 420e includes: FEC coded M/H service data, FEC coded signal data, main data, RS parity data or dummy data (510), forming 31 bytes; trellis initialization data (520), forming 12 bytes; and training data (530), forming 164 bytes and 207 bytes. The training data 530 refers to channel estimating information for synchronizing time of broadcast data. In an embodiment of the present invention, if the channel state is greater than or equal to a value of the fifth channel state when frames containing broadcast data that the user desires are received, the user terminal receives broadcast data located in B1 and B2, the first to fifth training sequences 420a to 420e, and the secondary RS frame located in B9 and B10.

The sixth training sequence 420f is located at the 15^{th} and 16^{th} segments in B7 and is transmitted sixth. The sixth training sequence 420f includes: FEC coded M/H service data, FEC coded signal data, main data, RS parity data or dummy data (510), forming 54 bytes; trellis initialization data (520), forming 12 bytes; and training data (530), forming 141 bytes and 207 bytes. The training data 530 refers to channel estimating information for synchronizing time of broadcast data. In an embodiment of the present invention, if the channel state is equal to or greater than a value of the sixth channel state when frames containing broadcast data that the user desires are received, the user terminal receives broadcast data located in B1 and B2, the first to sixth training sequences 420a to 420f, and the secondary RS frame located in B9 and B10.

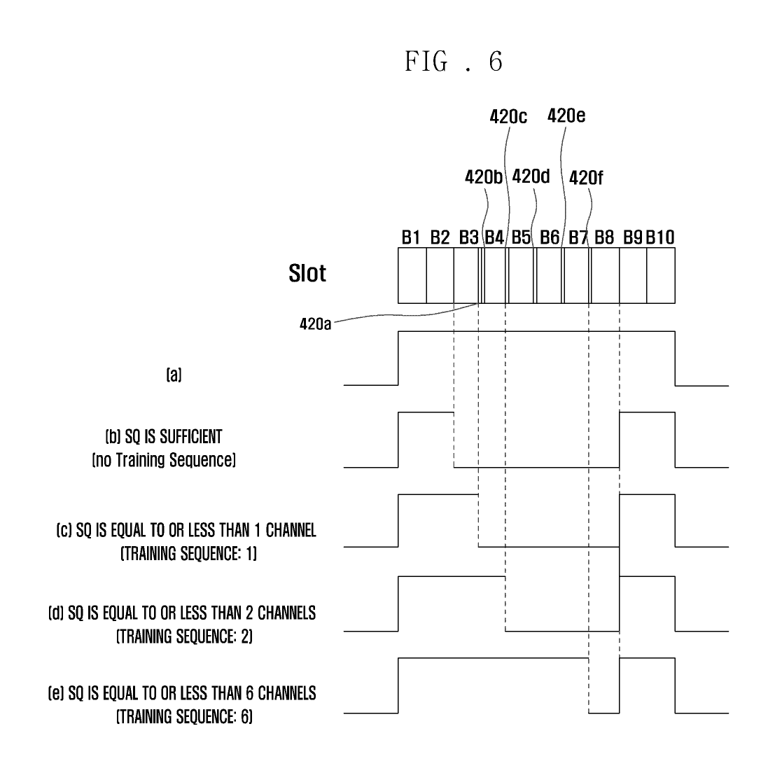

FIG. 6 is a timing chart for receiving data contained in a slot, according to an embodiment of the present invention.

Referring to FIG. 6, one slot is divided into B1 to B10, where the first training sequence 420a is located in B3, the second and third training sequences 420b and 420c are located in B4, the fourth training sequence 420d is located in B5, the fifth training sequence 420e is located in B6, and the sixth training sequence 420f is located in B7.

In wave form (a), it is assumed that the user terminal has received one slot without checking a channel state. When this occurs, the user terminal receives all broadcast data via the slot, and thus, does not turn off the frame receiving unit.

If the channel state (or Signal Quality (SQ)) is greater than or equal to the first channel state where a channel can be estimated without a training sequence, the user terminal receives only broadcast data in B1, B2, B9, and B10 of the areas forming the slot, which contain broadcast data corresponding to a user's selected channels, as shown in wave form (b). The user terminal turns off the frame receiving unit during the time that broadcast data in B3 to B8 can be received, thereby reducing power consumption.

If the SQ is greater than or equal to the second channel state, the user terminal receives only broadcast data in B1-B3 and the first training sequence 420a in B3 as shown in wave form (c). The user terminal does not turn on the frame receiving unit until the broadcast data in B9 starts to be received. Specifically, when it is time for the broadcast data in B9 to be received, the user terminal turns on the frame receiving unit and receives broadcast data in B9 and B10.

If the SQ is greater than or equal to the third channel state, the user terminal receives only broadcast data in B1-B4 and the first training sequence 420a to the second training sequence 420b in B4 as shown in wave form (d). The user terminal does not turn on the frame receiving unit until the broadcast data in B9 starts to be received. Specifically, when it is time for the broadcast data in B9 to be received, the user terminal turns on the frame receiving unit and receives broadcast data in B9 and B10.

If the SQ is greater than or equal to the sixth channel state, the user terminal receives only broadcast data in B1-B7 and the first training sequence 420a to the sixth training sequence 420f in B7 as shown in wave form (e). The user terminal does not turn on the frame receiving unit until the broadcast data in B9 starts to be received. Specifically, when it is time for the broadcast data in B9 to be received, the user terminal turns on the frame receiving unit and receives broadcast data in B9 and B10.

In the foregoing description, the method for receiving training sequences according to channel states has been provided. The following description provides the configuration of the user terminal adapted to the method.

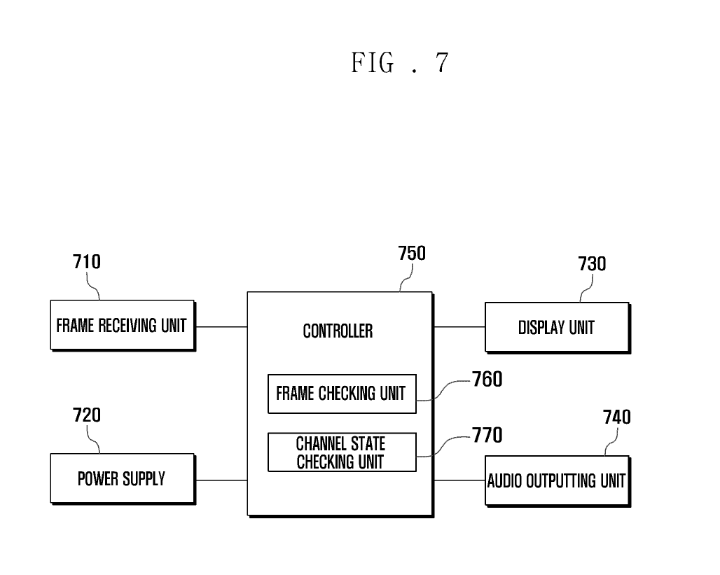

FIG. 7 is a schematic block diagram illustrating a broadcast receiving terminal, according to an embodiment of the present invention.

The user terminal includes a frame receiving unit 710, a power supply 720, a display unit 730, an audio processing unit 740, and a controller 750.

The frame receiving unit 710 tunes one of the frequencies allocated to broadcast service providers that provide broadcast data corresponding to a user's selected broadcast service. The frequencies refer to channels for providing broadcast services. The frame receiving unit 710 receives broadcast data corresponding to a user's requested broadcast service via the tuned frequency. The broadcast data is received based on frames. The frame receiving unit 710 may be turned on/off according to the number of the training sequences that are received according to a channel state under the control of the controller 750.

The power supply 720 supplies electric power to the elements in the user terminal. In particular, the power supply 720 can turn on/off the frame receiving unit 710 according to the number of received training sequences, under the control of the controller 750.

The display unit 730 displays the entire operation and state of the user terminal. The display unit 730 displays broadcast data corresponding to a user's selected broadcast service.

The audio processing unit 740 includes a speaker and outputs voice broadcast data transmitted from the controller 750.

The controller 750 controls the entire operation and state of the user terminal. In particular, the controller 750 includes a frame checking unit 760 for checking frames received via the frame receiving unit 710, and a channel state checking unit 770 for checking a channel state. The controller 750 controls the frame receiving unit 710 to tune a frequency to a broadcast service provider corresponding to a user's selected broadcast service.

The frame checking unit 760 checks an ensemble corresponding to a user's selected broadcast service from the received frame. The frame checking unit 760 determines whether broadcast data corresponding to a user's selected broadcast service is received via a primary RS fame or a secondary RS frame. The frame checking unit 760 detects the location of a training sequence for estimating a channel, using an FIC located at the foremost position in the parade. The frame checking unit 760 also detects the time that the broadcast data contained in the secondary RS frame is transmitted.

If the broadcast data is transmitted via the secondary RS frame, the channel state checking unit 770 calculates a Signal to Noise Ratio (SNR), Packet error, and Received Signal Strength Indication (RSSI) and checks the channel state.

The controller 750 receives, step by step, training sequences using the location detected by the frame checking unit 760, according to the channel state checked by the channel state checking unit 770. The controller 750 compares the checked channel state with a preset channel state reference value. The channel state reference value can be empirically determined. The controller 750 can determine the number of training sequences to be received at the current channel state, based on the channel state reference value. For example, the channel state reference value can be determined, according to the first to sixth channel states, as being: greater than or equal to 90 at the first channel state; greater than or equal to 75 but less than 90 at the second channel state; greater than or equal to 60 but less than 75 at the third channel state; greater than or equal to 45 but less than 60 at the fourth channel state; greater than or equal to 30 but less than 45 at the fifth channel state; greater than or equal to 15 but less than 30 at the sixth channel state; and less than 15 at the seventh channel state.

It is assumed that: no training sequences are received if a current channel state is equal to or greater than the first channel state; 1 training sequence is received if a current channel state is greater than or equal the second channel state; 2 training sequences are received if a current channel state is greater than or equal to the third channel state; 3 training sequences are received if a current channel state is greater than or equal the fourth channel state; 4 training sequences are received if a current channel state is greater than or equal to the fifth channel state; 5 training sequences are received if a current channel state is greater than or equal to the sixth channel state; and 6 training sequences are received if a current channel state is greater than or equal to the seventh channel state.

If the channel state checking unit 770 ascertains that the current channel state is 67, the controller 750 compares the current channel state with the channel state reference value. Since the third channel state, which is greater than or equal to 60 but less than 75, contains 67 of the current channel state, the controller 750 needs to receive four training sequences. Therefore, the controller 750 controls the frame receiving unit 710 to receive broadcast data, corresponding to a user's requested broadcast service, and the first to fourth training sequences.

After receiving the training sequences according to the channel state, the controller 750 turns off the frame receiving unit 710 before the remaining broadcast data starts to be received. The controller 750 then turns on the frame receiving unit 710, so that the frame receiving unit 710 can receive the remaining broadcast data. Specifically, of the broadcast data contained in the secondary RS frame received via B1, B2, B9 and B10 of the slot, the broadcast data in the B1 and B2 is received together with the training sequence. Therefore, when the remaining broadcast data in the B9 and B 10 is to be received, the controller 750 turns on the frame receiving unit 710. The time that the broadcast data in the B9 and B10 is received can be checked via the FIC.

In the foregoing description, although the embodiment of the present invention is implemented in such a way that the controller 750 includes the frame checking unit 760 and the channel state checking unit 770, it should be understood that the present invention is not limited to this embodiment. For example, the embodiment may be modified in such a way that the frame checking unit 760 and the channel state checking unit 770 are separately configured in the user terminal.

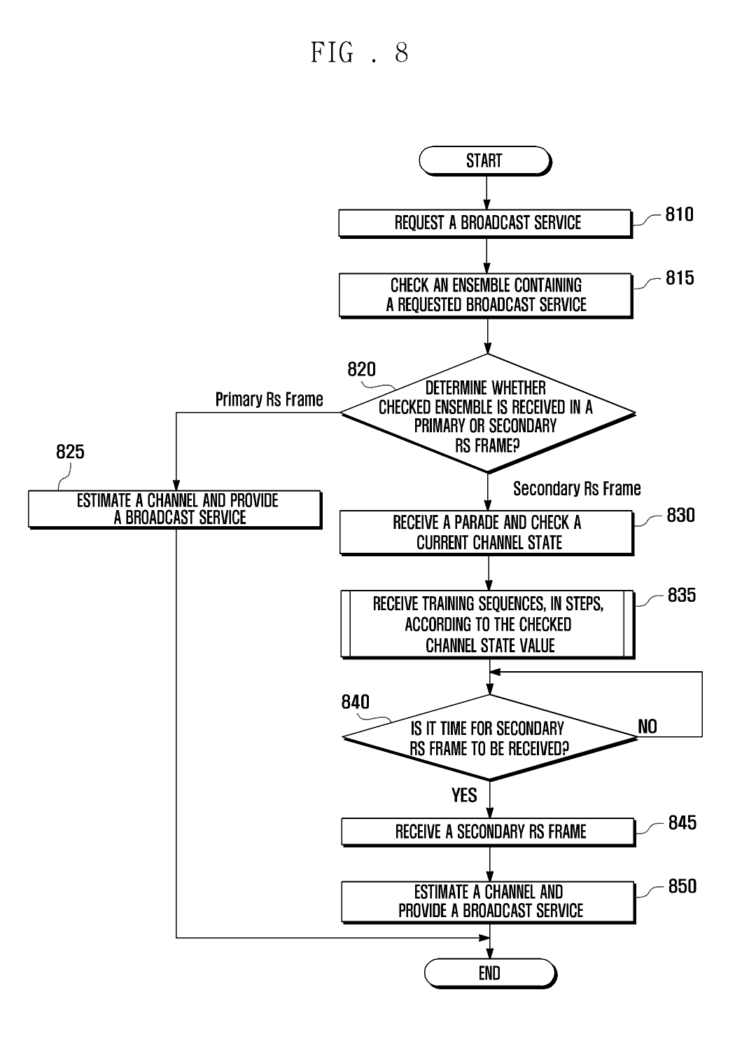

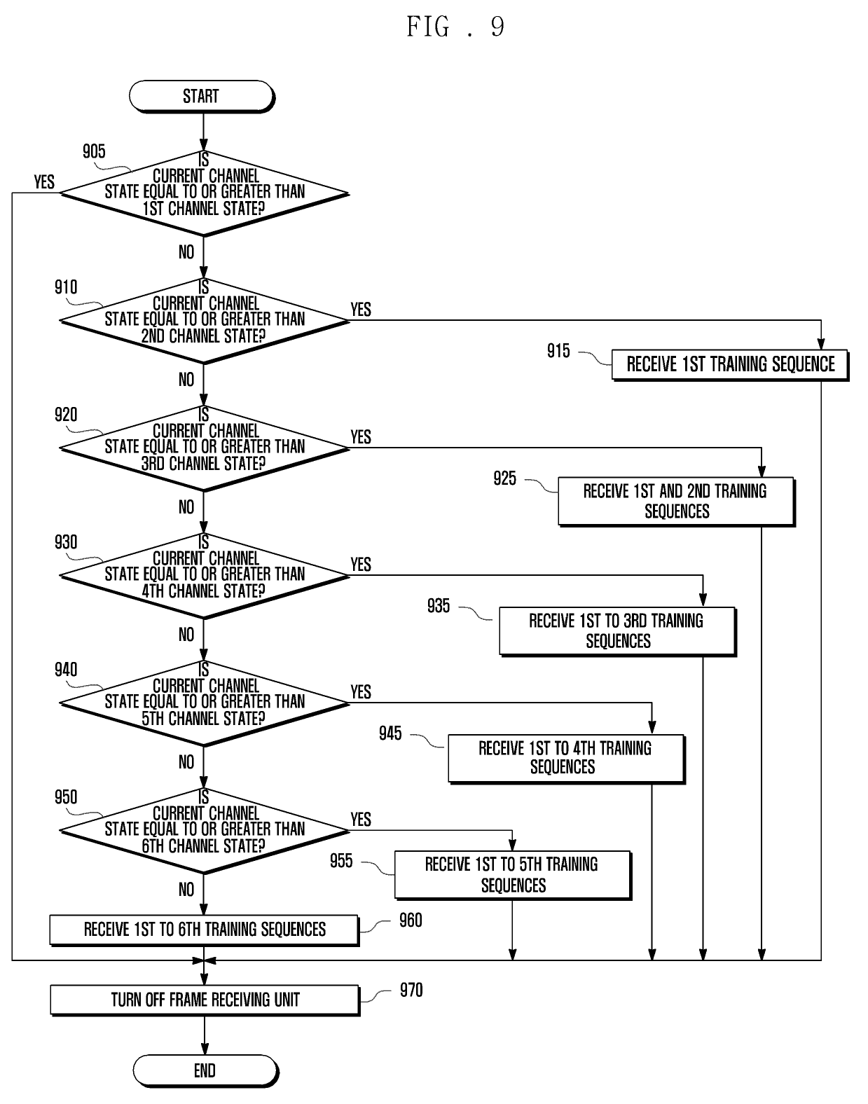

The following description provides a method for receiving broadcast data according to a channel state with reference to FIGS. 8 and 9.

FIG. 8 is a flow chart that illustrates a method for receiving frames, according to an embodiment of the present invention.

Referring to FIG. 8, when a user requests a broadcast service in step 810, the controller 750 checks an ensemble, containing broadcast data corresponding to a user's requested broadcast service, via the frame checking unit 760 in step 815. The controller 750 determines whether the checked ensemble is received via a primary RS fame or a secondary RS frame in step 820. The primary RS fame transmits the first broadcast data, such as images, moving images, etc. The secondary RS frame transmits the second broadcast data such as voice data of a radio broadcast service, traffic information, etc.

If the controller 750 ascertains that the checked ensemble is received via a primary RS fame at step 820, it receives the entire slot containing broadcast data in step 825. The controller 750 estimates a channel using all six training sequences in the slots and provides broadcast data corresponding to a user's requested broadcast service. The slot is divided into a plurality of areas B1 to B10. B1, B2, B9 and B 10 are areas for transmitting broadcast data contained in the secondary RS frame. B3 to B8 are areas for transmitting broadcast data contained in the primary RS fame. In particular, B3 to B7 contains six training sequences for estimating a channel.

If the controller 750 ascertains that the checked ensemble is received via a secondary RS frame at step 820, it receives one parade comprised of a primary RS fame and a secondary RS frame in step 830. The controller 750 checks the current channel state via the channel state checking unit 770. The controller 750 receives, step by step, training sequences according to the checked channel state value and the broadcast data corresponding to the secondary RS frame located in B1 and B2 in step 835, which will be explained in detail with reference to FIG. 9. The controller 750 receives training sequences according to a channel state and then turns off the frame receiving unit 710 before the remaining broadcast data is received.

The controller 750 determines whether it is time for broadcast data in B9 and B10, of the second broadcast data, to be received via the secondary RS frame in step 840. If the controller 750 ascertains that it is time for broadcast data in B9 and B10 to be received via the secondary RS frame at step 840, it turns on the frame receiving unit 710 and receives the broadcast data via the secondary RS frame therethrough in step 845. The controller 750 estimates a channel using received training sequences and provides broadcast data corresponding to a user's requested broadcast service in step 850.

FIG. 9 is a flow chart that illustrates a method for receiving a training sequence, according to an embodiment of the present invention.

Referring to FIG. 9, the controller 750 determines whether the current channel state is greater than or equal to the first channel state in step 905. If the current channel state is greater than or equal to the first channel state at step 905, the controller 750 receives broadcast data in B1 and B2, and turns off the frame receiving unit 710 before the broadcast data of the secondary RS frame, located in B9 and B10, starts to be received in step 970.

If the current channel state is less than the first channel state at step 905, the controller 750 determines whether the current channel state is greater than or equal to the second channel state in step 910. If the current channel state is greater than or equal to the second channel state at step 910, the controller 750 checks the number of training sequences to be received at the second channel state and receives the first training sequence and broadcast data located in B1 and B2 in step 915.

If the current channel state is less than the second channel state at step 910, the controller 750 determines whether the current channel state is greater than or equal to the third channel state in step 920. If the current channel state is greater than or equal to the third channel state at step 920, the controller 750 checks the number of training sequences to be received at the third channel state and receives the first and second training sequences and broadcast data located in B1 and B2 in step 925.

If the current channel state is less than the third channel state at step 920, the controller 750 determines whether the current channel state is greater than or equal to the fourth channel state in step 930. If the current channel state is greater than or equal to the fourth channel state at step 930, the controller 750 checks the number of training sequences to be received at the fourth channel state and receives the first to third training sequences and broadcast data located in B1 and B2 in step 935.

If the current channel state is less than the fourth channel state at step 930, the controller 750 determines whether the current channel state is greater than or equal to the fifth channel state in step 940. If the current channel state is greater than or equal to the fifth channel state at step 940, the controller 750 checks the number of training sequences to be received at the fifth channel state and receives the first to fourth training sequences and broadcast data located in B1 and B2 in step 945.

If the current channel state is less than the fifth channel state at step 940, the controller 750 determines whether the current channel state is greater than or equal to the sixth channel state in step 950. If the current channel state greater than or equal to the sixth channel state at step 950, the controller 750 checks the number of training sequences to be received at the sixth channel state and receives the first to fifth training sequences and broadcast data located in B1 and B2 in step 955.

If the current channel state is less than the sixth channel state at step 950, the controller 750 receives the first to sixth training sequences and broadcast data located in B1 and B2 in step 960.

After receiving the training sequences according to a channel state, the controller 750 turns off the frame receiving unit 710 before broadcast data of the secondary RS frame, located in the B9 and BIO, starts to be received in step 970 and then returns to the procedure of FIG. 8.

As described above, embodiments of the present invention can selectively receive necessary frames containing broadcast data, thereby reducing power to consumption, which causes an increase in operation time of the user terminal and increases the time required to receive broadcast data.

While the invention has been shown and described with reference to certain embodiments thereof, it will be understood by those skilled in the art that various changes in form and detail may be made therein without departing from the spirit and scope of the invention as defined in the appended claims.

What is claimed is:

1. A method for receiving frames containing broadcast data, comprising the steps of:
determining whether the broadcast data is transmitted via a primary RS frame for transmitting first broadcast data or a secondary RS frame for transmitting second broadcast data;
when the broadcast data is transmitted via the secondary RS frame for the second broadcast data, checking a channel state of a channel through which a frame containing the second broadcast data is transmitted; and
when the checked channel state is greater than or equal to a preset first channel state, receiving only the second broadcast data contained in the secondary RS frame.

2. The method of claim 1, further comprising:
when the checked channel state is less than the preset first channel state, receiving, step by step, training sequences for estimating a channel according to the checked channels state;
when the training sequences are received, turning off a frame receiving unit for receiving a frame containing the second broadcast data; and
when it is time for the second broadcast data contained in the secondary RS frame to be received, turning on the frame receiving unit.

3. The method of claim 2, further comprising:
comparing the channel state with a preset channel state reference value;
checking a number of the training sequences to be received, according to the comparison result; and
receiving the checked number of training sequences.

4. The method of claim 1, further comprising:
checking an ensemble containing a broadcast service to transmit the second broadcast data.

5. A broadcast data receiving terminal comprising:
a frame receiving unit for receiving broadcast data contained in at least one of a primary RS frame for transmitting first broadcast data and a secondary RS frame for transmitting second broadcast data;
a channel state checking unit for checking a channel state of a channel through which the broadcast data is transmitted; and
a controller for determining whether the broadcast data is the first broadcast data received via the primary RS frame or the second broadcast data received via the secondary RS frame, checking the channel state of the channel through which a frame containing the second broadcast data is transmitted when the broadcast data is the second broadcast data, receiving only the second broadcast data contained in the secondary RS frame when the checked channel state is greater than or equal to a preset first channel state.

6. The broadcast data receiving terminal of claim 5, wherein the controller receives, step by step, training sequences for estimating a channel according to the checked channels state when the checked channel state is less than the preset first channel state, turns off the frame receiving unit for receiving a frame containing the second broadcast data when the training sequences are received, and turns on the frame receiving unit when it is time for the second broadcast data contained in the secondary RS frame to be received.

7. The broadcast data receiving terminal of claim 6, wherein the controller compares the channel state with a preset channel state reference value, checks a number of the training sequences to be received according to the comparison result, and receives the checked number of training sequences.

8. The broadcast data receiving terminal of claim 6, wherein the controller checks an ensemble containing a broadcast service to transmit the broadcast data and determines whether a frame via which the broadcast data is received is the primary RS frame or the secondary RS frame.
